(19) United States
(12) Patent Application Publication
(10) Pub. No.: US 2004/0004690 A1
(43) Pub. Date: Jan. 8, 2004

(54) Liquid-crystal display device

(76) Inventors: Takeshi Yamaguchi, Kumagaya-shi (JP); Kisako Ninomiya, Fukaya-shi (JP); Yasushi Kawata, Ageo-shi (JP); Yuuzo Hisatake, Yokohama-shi (JP); Kazuyuki Sunohara, Kanazawa-shi (JP); Natsuko Fujiyama, Fukaya-shi (JP); Akio Murayama, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/427,944

(22) Filed: May 2, 2003

(30) Foreign Application Priority Data
May 8, 2002 (JP) 2002-132989

(51) Int. Cl. G02F 1/1343

(52) U.S. Cl. 349/141

(57) ABSTRACT

A liquid-crystal display device comprises an array substrate having pixel electrodes disposed on a main surface thereof, a counter substrate having a counter electrode disposed to face the pixel electrodes on the main surface of the array substrate, and a liquid-crystal layer held between the counter substrate and the array substrate. A pixel between the pixel electrode and the counter electrode is composed of four domains located around a center point of the pixel. Each of the domains includes stronger electric field regions and weaker electric field regions arranged alternately such that liquid-crystal molecules in the domains present four anisotropic alignment patterns deviated from each other by about 90°.

### CROSS-REFERENCE TO RELATED APPLICATIONS

This application is based on and claims the benefit of priority from the prior Japanese Patent Application No. 2002-132989 filed May 8, 2002, the entire contents of which are incorporated herein by reference.

### BACKGROUND OF THE INVENTION

1. Field of the Invention

This invention relates to a liquid-crystal display device, and more particularly to a liquid-crystal display device having display characteristics improved by dividing each of pixels corresponding to pixel electrodes into four domains each including first and second regions which are set in different electric field strength and arranged in such a manner that the four domains present anisotropy in a different direction from one another by about 90°.

2. Description of the Related Art

In present-day color liquid-crystal display devices, the active matrix color liquid-crystal display device is dominant because excellent images can be displayed without crosstalk between adjacent pixels. As shown in FIG. 10, the active matrix color liquid-crystal display device comprises an array substrate 57 which includes a substrate 51 made of transparent glass, switching elements, such as thin-film transistors (TFTs) 52 using amorphous silicon as a semiconductor layer and arrayed in a matrix on the substrate 51, a three-color (blue, green, red) filter 53 having colored layers 53B, 53G, 53R made of acrylic material or the like and covering the TFTs 52. In the array substrate 57, transparent pixel electrodes 55 of ITO or the like are disposed on the color filter layer 53 and connected to the TFTs 52 via through sections 54 formed in the color filter 53. Further, an alignment film 56 of polyimide or the like is formed to cover the surfaces of the pixel electrodes 55.

The active matrix color liquid-crystal display device further comprises a counter substrate 58 facing the array substrate 57. The counter substrate 58 comprises a substrate 59 made of transparent glass, a transparent counter electrode 60 of ITO or the like formed on a surface of the substrate 59 facing the array substrate 57, and alignment film 61 of polyimide or the like formed on the counter electrode 60.

Furthermore, a frame section 62 made of a black light-shielding film is provided to cover a non-display area surrounding the display area.

A silver paste (not shown) or the like is attached at the peripheral portions of the screen as an electrode transfer member which electrically connects the array substrate 57 and the counter substrate 58 to supply a voltage from the substrate 57 to the substrate 58.

The array substrate 57 and the counter substrate 58 are opposed to each other and spaced by spacers 63 interposed for defining a specific gap therebetween. These substrates 57 and 58 are bonded by a sealing member 64, which is made of a thermosetting or ultraviolet-curing acrylic or epoxy adhesive and applied along the peripheries of the substrates 57 and 58. A liquid-crystal panel 66 is obtained by applying a liquid-crystal layer 65 into a space (or cell) surrounded by the sealing member 64 between the substrates 57 and 58.

The spacers 63 can be made of the same material as that of the colored layers 53G, 53B, 53R serving as the color filter layer 53. Thus, the spacers 63 are formed by patterning the material stacked on the colored layers 53G, 53B, 53R using photolithographic techniques in the process of forming the color filter layer 53, so as to reduce the number of processes.

Furthermore, polarizing plates 67 are fixed to both the outer surfaces of the liquid-crystal panel 66 with adhesive. A backlight or a reflector (not shown) is provided outside the polarizing plate 67 on the array substrate 57 side, as needed, thereby configuring a color liquid-crystal display device.

The above-mentioned color liquid-crystal display device display turns on the backlight serving as, for example, a light source, and performs switching control of the pixel electrodes 55 by driving TFTs 52. As a result, the liquid-crystal layer 65 on each pixel electrodes 55 is controlled according to the potential difference between the pixel electrode 55 and the counter electrode 60 and serves as an optical shutter to display a specific color image.

Recent years, a higher resolution and higher display speed are demanded for the color liquid-crystal display device to cope with an increase in the amount of information to be displayed. A higher resolution can be achieved by miniaturizing the structure of components in the array substrate 57. A higher display speed is currently under investigation, taking into account the adoption of various modes using nematic liquid crystal and the adoption of an interface stable ferroelectric liquid crystal mode using smectic liquid crystal or an antiferromagnetic liquid crystal mode.

Of the above display modes, the VAN (Vertical Aligned Nematic) mode is promising, in which a response speed higher than that in a conventional TN mode is obtained without requiring any rubbing process for vertical alignment. In particular, the multi-domain VAN mode has attracted particular attention because the compensating design of viewing angles is relatively easy.

Generally, when the multi-domain VAN mode is adopted, ridge projections are formed not only on the array substrate 57 but also on the counter substrate 58. Alternatively, slits or the like are formed in the counter electrode 60 of the counter substrate 58. Therefore, the array substrate 57 must be aligned with the counter substrate 58 with a very high accuracy using an alignment mark or the like, which might result in an increase in the cost or a decrease in the reliability.

Furthermore, in recent TN-mode color liquid-crystal display devices, the color filter layer 53 is formed on the array substrate 57 side, as described above. The technique of providing the color filter layer 53 on the array substrate 57 side has the advantage of eliminating the need to align the colored layers 53G, 53B, 53R, constituting the color filter layer 53, with the pixel electrodes 55 when the array substrate 57 and the counter substrate 58 are integrated to form a liquid-crystal panel 66.

It seems that the above-mentioned technique is applicable to a multi-domain VAN-mode color liquid-crystal display device. However, in a conventional multi-domain VAN-mode color liquid-crystal display device, the alignment of the ridge projections or slits is still needed in the process of integrating the array substrate 57 and the counter substrate 58 to form a liquid-crystal panel 66. For this reason, even when the color filter layer 53 is formed on the array substrate 57 side in the multi-domain VAN-mode color liquid-crystal display device, it is impossible to eliminate the need for alignment as found in the TN-mode color liquid-crystal display device. In addition, further improvements have been required to secure higher transmittance and a wider viewing angle.

### BRIEF SUMMARY OF THE INVENTION

It is accordingly an object of the present invention to provide a liquid-crystal display device which overcomes these disadvantages, by particularly improving the shape of pixel electrodes.

According to the invention, there is provided a liquid-crystal display device which comprises an array substrate having pixel electrodes disposed on a main surface thereof; a counter substrate having a counter electrode disposed to face the pixel electrodes on the main surface of the array substrate; and a liquid-crystal layer held between the counter substrate and the array substrate; wherein a pixel between the pixel electrode and the counter electrode is composed of four domains located around a center point of the pixel and each including stronger electric field regions and weaker electric field regions arranged alternately such that liquid-crystal molecules in the domains present four anisotropic alignment patterns deviated from each other by about 90°.

With the liquid-crystal display device, a high-accuracy alignment is not needed. In addition, the display characteristics concerning the transmittance, response time and afterimage are improved by dividing a pixel defined between the pixel electrode and the counter electrode into four domains located around a center point of the pixel and each including two types of electric field regions different in electric field strength arranged alternately such that liquid-crystal molecules in the domains present four anisotropic alignment patterns deviated from each other by about 90°.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIGS. 1A and 1B are a sectional view of a liquid-crystal display device and a plan view of a pixel electrode pattern according to a first embodiment of the present invention;

FIG. 2 is a sectional view showing the configuration of an array substrate for the liquid-crystal display device of FIG. 1A;

FIG. 3 is a circuit diagram showing the configuration of the liquid-crystal display device shown in FIG. 1A;

FIGS. 4A and 4B are diagrams showing the basic structure of the pixel electrode for the liquid-crystal display device of FIG. 1A and the pixel state obtained in an operation thereof;

FIGS. 5A to 5D are diagrams for explaining the alignment states of liquid-crystal molecules in the liquid-crystal display device of FIG. 1A;

FIGS. 6A and 6B are plan views of first and second modifications of the pixel electrode pattern constituting the liquid-crystal display device of FIG. 1B;

FIGS. 7A to 7D are plan views of third to sixth modifications of the pixel electrode pattern constituting the liquid-crystal display device of FIG. 1B;

FIGS. 8A to 8C are plan views of a seventh to a ninth modification of the pixel electrode pattern constituting the liquid-crystal display device of FIG. 1B;

FIGS. 9A and 9B are plan views of a tenth and an eleventh modification of the pixel electrode pattern constituting the liquid-crystal display device of FIG. 1B; and

FIG. 10 is a sectional view of a conventional liquid-crystal display device.

### DETAILED DESCRIPTION OF THE INVENTION

Hereinafter, a color liquid-crystal display device according to an embodiment of the present invention will be explained in detail, with reference to accompanying drawings.

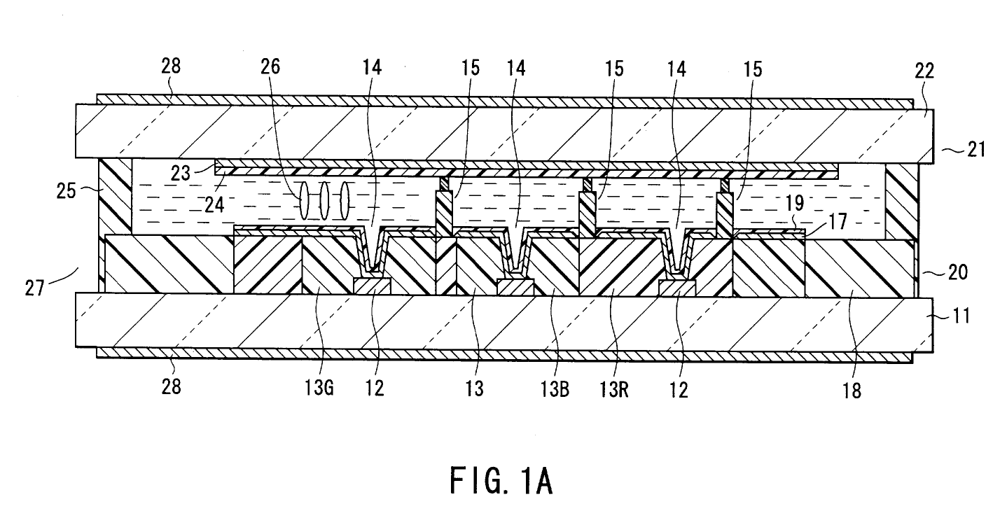

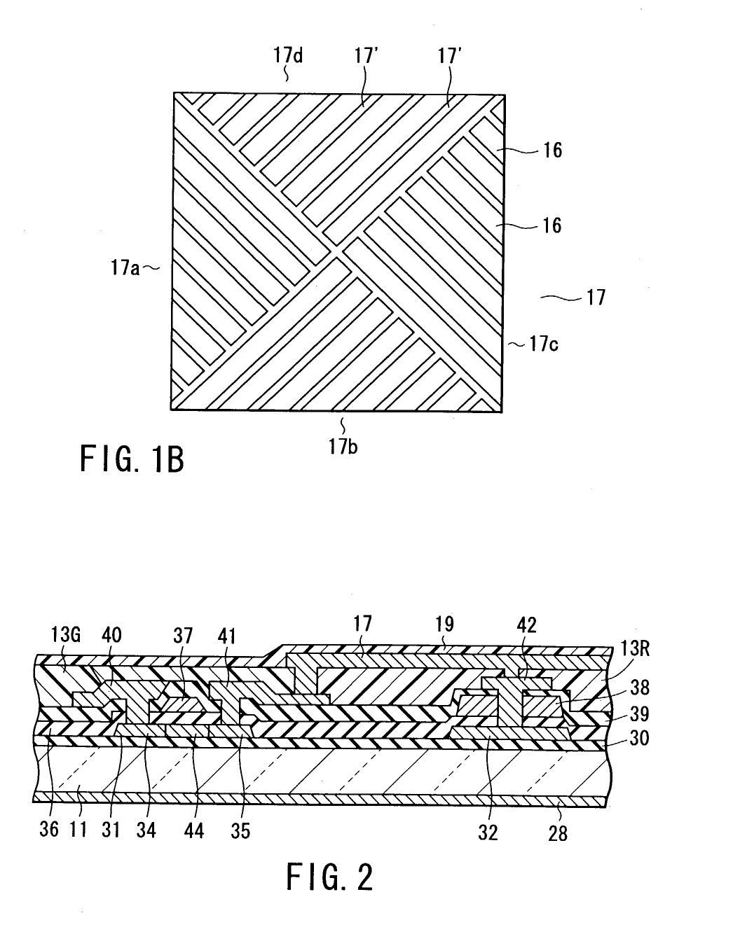

As shown in FIG. 1A, in the color liquid-crystal display device, electrode wiring and switching elements, such as TFTs 12, are provided at the main surface of a transparent glass substrate 11 by making full use of micro-fabrication techniques, including film formation and patterning.

Around the TFTs 12, RGB colored layers 13R, 13G, 13B, which serve as a color filter layer 13 colored red (R), blue (B), green (G), are each provided in stripe form. For example, when a first color is red, a red-pigment-dispersed ultraviolet-curing acrylic resin resist is uniformly applied to the whole surface of the substrate 11 with a spinner. Then, with such a photomask pattern as allows light to be projected on the part to be colored red, ultraviolet rays with a wavelength of 365 nm are projected at an intensity of 100 mJ/cm² for exposure. The photomask pattern has a striped pattern part corresponding to the first color and a square pattern part for stacked spacers.

Thereafter, the pattern is developed in a 1% KOH solution for 20 seconds, thereby forming red colored layers 13R with a film thickness of 3.2 μm in the pattern part. Then, the green colored layers 13G and the blue colored layers 13B are formed in the same manner described above. At this time, contact hole sections 14 are made in parts of the TFTs 12. In the process of patterning the material of the color filter layer 13, stacked spacers 15, formed by stacking the materials of the colored layers 13R, 13G, 13B of the color filter layer 13 one after another, are formed together with the formation of the colored layers 13R, 13G, 13B, in such a manner that the spacers are arranged between the patterns of the selected color pixels.

Then, on the color filter layer 13, a light transmitting conductive member, such as ITO, is formed to a thickness of 1500 Å by sputtering techniques. The member is then patterned by photolithographic techniques, thereby forming transparent pixel electrodes 17 each of which has slits 16 in it, as shown in FIG. 1B. The pixel electrodes 17 are formed on parts of the color filter layer 13 allocated to the electrodes 17. Each pixel electrode 17 is connected to the source-drain path of the TFT 12 via a contact hole section 14. A black light-shielding film is provided as a frame section 18 surrounding the color filter layer 13 or the display area by photolithographic techniques. On the pixel electrodes 17, polyimide or the like is applied to form an alignment film 19 having a thickness of 600 Å. An array substrate 20 is formed as described above.

On the other hand, a counter substrate 21 is arranged to face the array substrate 20. The counter substrate 21 is formed as follows. An ITO film is disposed on the facing surface of a transparent glass substrate 22 by sputtering techniques to form a counter electrode 23 having a thickness of 1500 Å. On the counter electrode 23, polyimide or the like is applied to form the alignment film 24 having a thickness of 600 Å. This alignment film 24 and the alignment film 19 of the array substrate 20 provide vertical alignment of the liquid-crystal molecules without requiring a rubbing process.

The peripheral parts of the counter substrate 21 and array substrate 20 are thermally bonded with a seal material 25 made of thermoset epoxy adhesive, excluding the inlet, to form a cell between the counter substrate 21 and the array substrate 20 with a gap determined by spacers 15. Electrode transfer members for applying a voltage from the array substrate 20 to the counter substrate 21 are attached to electrode transfer pads (not shown) outside the seal material 25. A liquid-crystal material made of, for example, a fluoric liquid-crystal compound is injected from the inlet into the cell, thereby forming a liquid-crystal display layer 26. Thereafter, the inlet is sealed with ultraviolet-curing resin as a final step of forming a liquid-crystal panel 27. Furthermore, polarizing plates 28 are bonded to the outer surfaces of the array substrate 20 and counter substrate 21 of the liquid-crystal panel 27. Outside the polarizing plate 28 on the array substrate 20 side, a backlight, a reflector (not shown), or the like is provided as needed, thereby configuring the color liquid-crystal display device.

Each pixel electrode 17 is composed of four parts 17a to 17d, the areas of which are almost equal to each other as shown in, for example, FIG. 1B. Each of the parts 17a to 17d has slits 16 and electrode sections 17′. The slits 16 and electrode sections 17′ of the parts 17a to 17d are arranged alternately to form electrode patterns having different orientations of about 90° among the parts 17a to 17d. For example, when the electrode pattern of the part 17a is rotated through an angle of 90°, it coincides with the pattern of the part 17b. When the pattern of the part 17a is rotated through another 90°, it coincides with the pattern of the part 17c. When the pattern is rotated through a further 90°, it coincides with the pattern of the part 17d. That is, these patterns are rotationally symmetric at about 90°, but not axial-symmetric between the adjacent parts. With this structure, anisotropy is achieved in four directions.

The TFTs 12, pixel electrodes 17, scanning lines, signal lines, etc., are configured as shown in FIG. 2.

Specifically, an undercoat layer 30 is formed on the main surface of the substrate 11. Semiconductor layers 31 for the TFTs 12 and storage capacitance electrodes 32 are disposed on the undercoat layer 30. the semiconductor layer 31 is made of a polysilicon film, and the storage capacitance electrode 32 is made of an impurity-doped polysilicon film. The semiconductor layer 31 has a drain region 34 and a source region 35 on both sides of a channel region 33. The drain region 34 and source region 35 are obtained by doping impurities. On the semiconductor layers 31 and storage capacitance electrodes 32, a gate insulating film 36 is provided. The gate insulating film 36 has contact holes formed for the drain region 34, source region 35, and storage capacitance electrode 32.

On the gate insulating film 36, scanning lines 37, each serving as a gate electrode, and storage capacitance lines 38, are formed. An interlayer insulating film 39 is formed to cover the scanning lines 37 and storage capacitance lines 38, and has contact holes formed in communication with the contact holes of the gate insulating film 36. Signal lines 40 each serving as a drain electrode, source electrodes 41, and contact electrodes 42 are formed on the interlayer insulating film 39. The signal line 40 is electrically connected to the drain region 34 via the contact hole located thereon. The source electrode 41 is electrically connected to the source region 35 via the contact hole located thereon. The contact electrode 42 is electrically connected to the storage capacitance electrode 32 via the contact hole located thereon.

On the interlayer insulating film 39 including the signal line 40, source electrode 41, and contact electrode 42, colored layers such as red colored layers 13R, green colored layers 13G, and blue colored layers 13B are disposed to form the color filter layer 13. The colored layer 13R has contact holes formed on the source electrode 41 and contact electrode 42. Each of the pixel electrodes 17 is formed on one of the colored layers 13R, 13G, and 13B, and is electrically connected to the source electrode 41 and contact electrode 42 via the contact holes. The alignment film 19 is formed on the colored layers 13R, 13G, and 13B and the pixel electrodes 17. Although the pixel electrodes 17 on the green colored layer 13G and the blue colored layer 13B are not shown, they are formed in the same manner as that of the pixel electrodes on the red colored layer 13A.

The scanning lines 37 are formed along rows of the pixel electrode 17. The signal lines 40 are formed along columns of the pixel electrode 17. The signal lines 40 almost perpendicularly intersect the scanning lines 37 and storage capacitance lines 38. The storage capacitance electrode 32 is set to the same potential as that of the pixel electrode 17. The storage capacitance line 38 is set to a predetermined potential. The TFTs 12 are disposed near intersections of the scanning lines 37 and the signal lines 40. The scanning line 41 and storage capacitance line 38 are made of molybdenum-tungsten. The signal line 40 is made mainly of aluminium.

While only the alignment films 19, 24 are provided on the pixel electrode 17 and counter electrode 23, the liquid-crystal panel 27 may include an insulating film (not shown) optionally provided on the electrodes 17, 23 to cope with a variety of purposes. An inorganic thin film made of, for example, SiO₂, SiN_{X}, or Al₂O₃, or an organic thin film made of, for example, polyimide, photoresist resin, or macromolecular liquid crystal may be used as the insulating film. When the insulating film is an inorganic thin film, it may be formed by vapor deposition, sputtering, CVD, or solution applying techniques. When the insulating film is an organic thin film, an organic-matter-dissolved solution may be applied by a spinner applying method, a screen print applying method, a roll applying method, or the like and then hardened under specific hardening conditions, such as heating or light projection. Alternatively, when the insulating film is an inorganic thin film, it may be formed by vapor deposition, sputtering, CVD, or LB techniques.

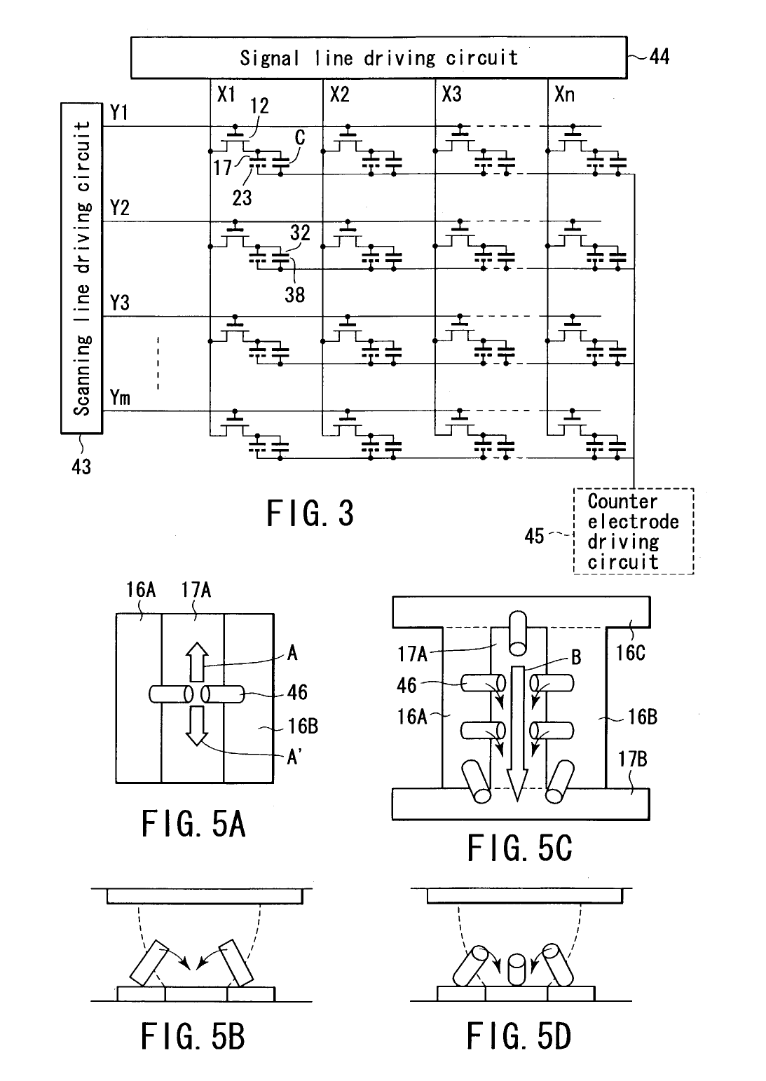

As shown in FIG. 3, an equivalent circuit of the array substrate 20 configured as described above includes m×n pixel electrodes 17 arranged in a matrix, an m number of scanning lines Y (41 or Y1 to Ym) formed in the row direction of the pixel electrodes 17, an n number of signal lines X (40 or X1 to Xn) formed in the column direction of the pixel electrodes 17, and m×n TFTs 12 arranged near intersections of the scanning lines Y1 to Ym and the signal lines X1 to Xn, as switching elements for the m×n pixel electrodes 17.

Each TFT 12 has a gate electrode 37 connected to one scanning line Y formed along a row of the pixel electrodes 17 and a source electrode 41 connected to one signal line X formed along a column of the pixel electrodes 17. In operation, the TFT 12 is made conductive by a driving voltage supplied via the scanning line Y from a scanning line driving circuit 43 so as to apply a signal voltage from a signal line driving circuit 44 to the pixel electrode 17 via the source-drain path thereof.

A storage capacitance C is composed of a storage capacitance electrode 32 set to the same potential as that of the pixel electrode 17 and a storage capacitance line 38 set to a predetermined potential, and is connected in parallel with a liquid-crystal capacitance between the pixel electrode 17 and the counter electrode 23. To the counter electrode 23, a driving voltage is applied from a counter electrode driving circuit 45.

The basic structure of the pixel electrode 17 is shown in FIG. 4A. That is, one pixel electrode 17 is quadrisected so that it may be composed of four parts 17a to 17d of almost the same area. In the individual parts 17a to 17d of the pixel electrode 17, a plurality of slits 16 are made in parallel with each other at regular intervals. The longitudinal direction of the slits 16 is set so that they may be rotationally symmetric at 90° to one another in such a manner that the longitudinal direction differs from one part from another among the parts 17a to 17d, for example, the longitudinal direction in each part inclines at 45° with respect to 2-dimensional axes (or XY axes) and their prolonged lines cross one another at the middle point.

Making the slits 16 this way causes stronger electric fields to be located over the electrode sections 17′ of the pixel electrode 17 and weaker electric fields to be located over the slits 16. Since the slits 16 for the parts 17a to 17d are set in the different directions, anisotropy is so produced that stronger and weaker electric fields present four different directional components.

When a nematic liquid-crystal material having negative dielectric anisotropy is used as the liquid-crystal layer 26, liquid-crystal molecules 46 are aligned in such a manner that the tilt direction (director) is parallel to the direction in which stronger and weaker electric fields are arranged alternately. Since different alignment directions of the liquid-crystal molecules are caused by the four parts 17a to 17d, the pixel is divided into four domains differing in the tilt direction of the liquid-crystal molecules 46 in operation. At this time, the pixel is in a pixel state shown in FIG. 4B, according to the parts 17a to 17d of the pixel electrode 17. In summary, anisotropic alignment patterns of the liquid-crystal molecules are presented in the domains caused by the parts 17a to 17d. The anisotropic alignment pattern in the domain caused by the part 17a is deviated from the anisotropic alignment patterns in the remaining domains caused by the parts 17b to 17d by about 90°, 180°, and 270° , respectively.

With the structure, the alignment of the liquid-crystal molecules 46 changes as follows. When no voltage is applied between the pixel electrode 17 and the counter electrode 23, the alignment films 19, 24 serve to vertically align the liquid-crystal molecules 46 of the negative dielectric anisotropy in the liquid-crystal layer 26. More specifically, the liquid-crystal molecules 46 are aligned such that their major axes are almost perpendicular to the film surface of the alignment films 19, 24.

Then, when a first voltage of relatively low level is applied between the pixel electrode 17 and the counter electrode 23, a leakage electric field is generated above the slits 16 of the pixel electrode 17. Specifically, when the stronger electric field region 17A is located in one direction between the weaker electric field regions 16A, 16B generated above the slits 16, as shown in FIG. SA, inclined electric flux lines are obtained according to a leakage electric field from the stronger electric field region 17A to the weaker electric field regions 16A, 16B. Since the dielectric anisotropy of the liquid-crystal molecules 46 develops along the inclined electric flux lines, the liquid-crystal molecules 46 near the electric flux lines tilt in a specific direction. The tilts caused by the weaker electric field regions 16A, 16B facing each other have directional components interfering with one another. Thus, it is presumed that tilt relaxation will take place toward a lower energy state.

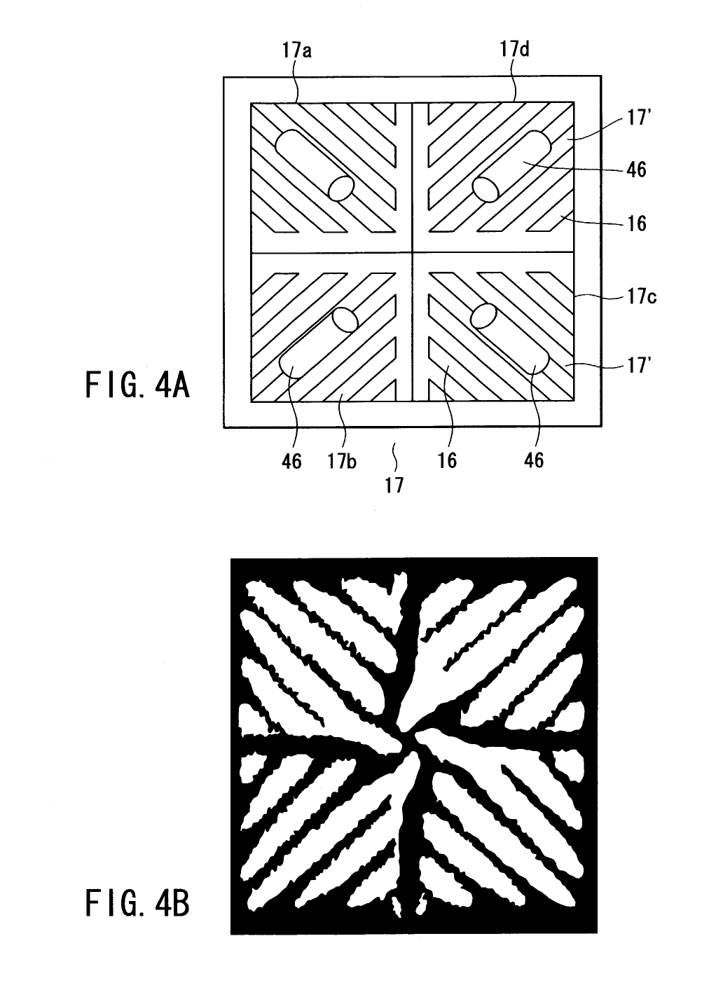

Since the alignments of the liquid-crystal molecules 46 in the weaker electric field regions 16A, 16B and the stronger electric field region 17A have only two-dimensional anisotropy, tilt relaxation occurs in the same probability in the two directions A, A′ shown by the arrows in FIG. 5A. Specifically, the electric field generated by applying a voltage between the pixel electrode 17 and the counter electrode 23 causes the liquid-crystal molecules 46 to be aligned in a direction perpendicular to the electric flux line. Thus, interference between the alignment of the right-side liquid-crystal molecules 46 and the alignment of the left-side liquid-crystal molecules 46 are caused by the alignment films 19, 24 and the electric field. As a result, the tilt direction of the liquid-crystal molecules 46 changes to the up direction A or the down direction A′ in the figure so as to establish a more stable alignment state.

As shown in FIG. 5A, the electrode section 17′ is located between a pair of slits 16 in the pixel electrode 17 and its vicinity have a symmetric or isotropic shape with respect to the directions A, A′, the probability that the liquid-crystal molecules 46 will tilt in the direction A becomes equal to the probability that the liquid-crystal molecules 46 will tilt in the direction A′. Such a structure is not reliable in that it is unknown whether the tilt direction of the liquid-crystal molecules 46 changes to the direction A or the direction A′.

In FIGS. 5C and 5D, a stronger electric field region 17B is provide at one longitudinal end of an isotropic region composed of the weaker electric field regions 16A, 16B and the stronger electric field region 17A, and a weaker electric field region 16C is provided at the other the longitudinal end of the isotropic region. In this case, a three-dimensional anisotropy is caused by the stronger electric field regions 17A, 17B and the weaker electric field regions 16A to 16C. The tilt relaxation of the liquid-crystal molecules 46 in the isotropic region occurs in an average tilt direction B as shown by the arrow in the figure.

In other words, when the voltage applied between the pixel electrode 17 and the counter electrode 23 is raised to a second voltage higher than the first voltage, the action of the electric field to align the liquid-crystal molecules 46 in a direction perpendicular to the electric flux line becomes greater than the action of the alignment films 19, 24 to align the liquid-crystal molecules 46 vertically. Thus, the tilt angle of the liquid-crystal molecules 46 changes to attain an alignment state closer to a horizontal alignment.

Even when the voltage applied between the pixel electrode 17 and the counter electrode 23 is raised to the second voltage higher than the first voltage, the alignment state where the liquid-crystal molecules 46 are aligned in the direction shown by the arrow A′ is more stable than the alignment state where the liquid-crystal molecules 46 are aligned in the direction shown by the arrow A.

Therefore, when the voltage applied between the pixel electrode 17 and the counter electrode 23 is varied between the first and second voltages, the tilt direction of the liquid-crystal molecules 46 vary in a plane perpendicular to the direction in which the slits 16 are arranged. That is, when the voltage applied between the pixel electrode 17 and the counter electrode 23 is varied between the first and second voltages, the tilt angle of the liquid-crystal molecules 46 changes, while keeping the average tilt direction in a plane perpendicular to the direction in which the slits 16 are arranged.

Consequently, the longitudinal direction of the slits 16 is set in a different direction in each of the four parts 17a to 17d of the pixel electrode 17, which enables the tilt angle to be changed, with the tilt direction of the liquid-crystal molecules 46 remaining unchanged. Specifically, since the pixel electrode 17 provided at the array substrate 20 produces the stronger electric field regions 17A, 17B and the weaker electric field regions 16A to 16C, four domains differing in the tilt direction of liquid-crystal molecules 46 can be obtained in one pixel. Further, the tilt angle of the liquid-crystal molecules 46 can be changed, while keeping the average tilt direction in a plane perpendicular to the direction in which the slits 16 are arranged, a faster response speed can be realized, alignment failure is less liable to take place, and a good alignment division can be made.

With such a structure, the tilt direction in the liquid-crystal layer 26 depends on the anisotropic electrode pattern. The liquid-crystal molecules 46 are aligned to form four domains of the same area oriented in directions at 0°, 90°, 180°, and 270°. Since these domains compensate for each other's viewing angle characteristic, it is possible to construct a liquid-crystal display device with a wide viewing angle characteristic.

Further, when a predetermined voltage is applied between the pixel electrode 17 and the counter electrode 23, the alignments of liquid-crystal molecules 46 are controllable by first type regions and second type regions, that is, stronger electric field regions and weaker electric field regions, which are shaped to extend in one direction within the pixel of the liquid-crystal layer 26 and are arranged alternately in a direction crossing the one direction. In addition, the first and second type regions are obtained by the structure provided on the array substrate 20 side against the counter substrate 21. Therefore, it is possible to attain an excellent effect that the array substrate 20 and the counter substrate 21 can be bonded without requiring a high-accuracy positional adjustment using an alignment mark, for example.

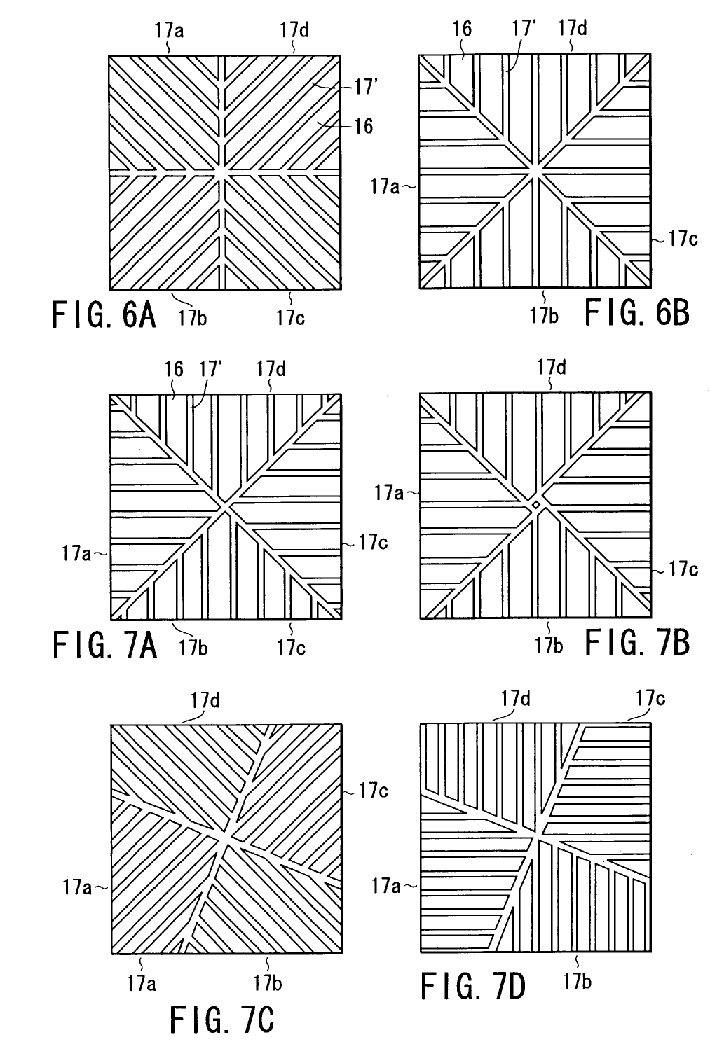

An electrode shown in FIG. 4A is actually formed in patterns shown in FIGS. 6A and 6B. With these patterns, the alignment of the liquid-crystal molecules 46 tend to change in directions at 0°, 90°, 180°, and 270° by the switching of the voltage in the central part where the parts 17a to 17d with anisotropy in four different directions contact one another. The liquid-crystal molecules 46 tilt toward the central part to form a cross pattern.

Since such an alignment state has elastic energy with a great splay deformation, it becomes unstable. Thus, relaxation is made by twist deformation that brings the unstable state into an alignment state where the alignment direction successively changes in a lower energy state. The pattern of the pixel electrode 17 shown in FIGS. 6A and 6B has anisotropy which is symmetric in an up and down direction and a right and left direction and permits right and left twist deformation of liquid-crystal molecules to take place in the same probability. In this case, a time lag in relaxation occurs at a point where the right and left twist deformations take place in the same probability. Therefore, there is a possibility that a slight change in brightness due to the time lag will be perceived as an afterimage in the liquid-crystal display device manufactured as a product.

To cope with the time lag in relaxation, as shown in FIG. 1B, the pixel electrode 17 is composed of the first part 17a to the fourth part 17d whose patterns are rotationally symmetric to coincide with those rotated at intervals of 90°, but not axial-symmetric between the adjacent parts. This structure provides anisotropy in four directions that enables the alignment of the liquid-crystal molecules 46 to tend to change in directions at 0°, 90°, 180°, and 270° by the switching of the voltage in the central part where the individual parts contact one another and to make a spiral going toward a point shifted from each center in the same direction. With this alignment, it is possible to bring the liquid-crystal molecules 46 immediately into the stable state of the left twist, since the left twist deformation has lower energy than the right twist deformation. As a result, the relaxation time can be shortened, which makes it difficult for an afterimage to take place.

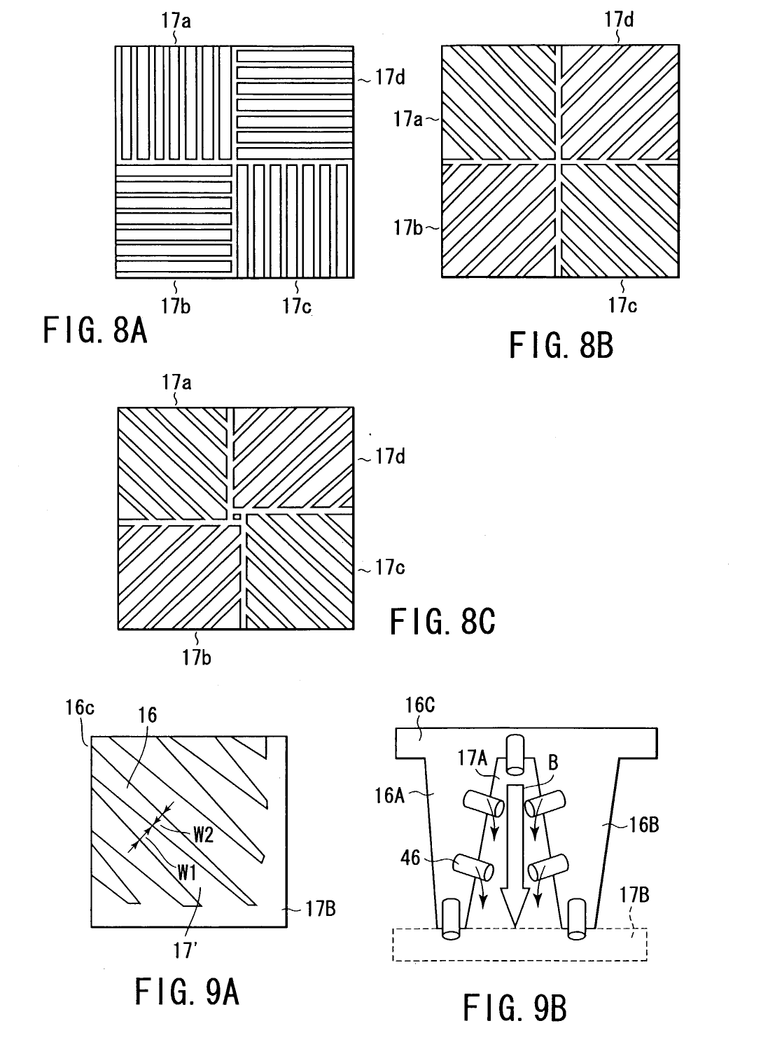

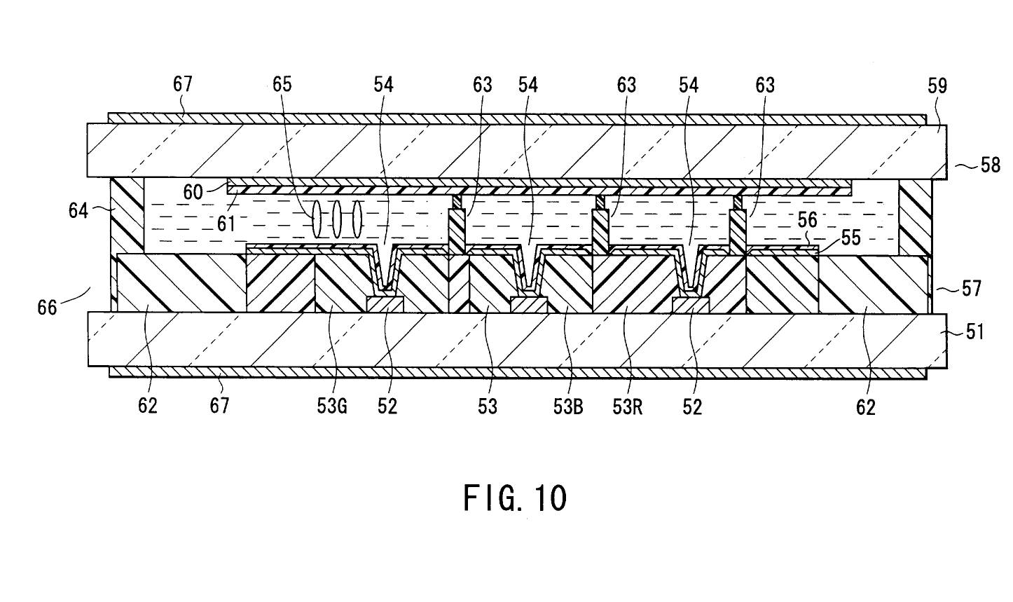

The patterns causing the liquid-crystal molecules 46 to make a spiral change in the alignment are not limited to those shown in FIG. 1B. For instance, a diagonally divided pattern arrangement in the four parts 17a to 17d of the same area as shown in FIGS. 7A to 7D, or a squarely divided pattern arrangement in the four parts 17a to 17d of the same area as shown in FIGS. 8A to 8C may be used. In short, patterns which present rotational symmetry four times and are not axially symmetric can be used.

Furthermore, while in the embodiment, the width of the slit 16 is constant, the width of the slit 16 may be varied along its longitudinal direction as shown in FIG. 9A. In this case, the alignment state of the liquid-crystal molecules 46 is as shown in FIG. 7B. The figure shows a part of one part 17a of the four parts 17a to 17d constituting the pixel electrode 17. With such a configuration, the width of the slit 16 increases continuously from the central part of the pixel electrode 17 toward its periphery. Use of such a configuration causes not only the liquid-crystal alignment at the lower end of the slit 16 and the liquid-crystal alignment at the upper end of the part located between the slits 16 of the pixel electrode 17 but also the liquid-crystal alignment at both ends of the slit 16 to act so that the tilt direction may be as shown by the arrow B. Thus, the transmittance and the response speed can be improved further.

As described above, making the slits 16 in the pixel electrode 17 causes an electric field distribution to be generated in such a manner that a stronger electric field region and a weaker electric field region are arranged alternately and periodically in each domain. When the slits 16 are used in this way, the design can be made with a relatively high degree of freedom. Furthermore, the design can be coped with only by modifying the pattern of the pixel electrode 17, which results in no increase in the number of manufacturing processes and no rise in the cost.

Such an electric field distribution can be generated by another method.

Specifically, instead of making the slits 16 in the pixel electrode 17, a dielectric layer 47 of the same pattern as that of the slits 16 may be provided on the pixel electrode 17. In this case, if the permittivity of the dielectric layer 47, such as acrylic resin, epoxy resin, or novolac resin, is lower than the permittivity of the liquid crystal material, a weaker electric field region can be formed above the dielectric layer 47. Thus, this produces the same effect as when the slits 16 are formed.

Furthermore, instead of making the slits 16 in the pixel electrode 17, wiring (not shown) may be provided on the pixel electrode 17 via a transparent insulating layer (not shown). For example, the signal lines 40, scanning lines 37, and storage capacitance lines 38 may be used as the wiring. They may be arranged in the same pattern as that of the slits 16. With such a structure, a stronger electric field region can be formed above the wiring. This produces the same effect as when the slits 16 are formed.

When the liquid-crystal display device is of the transmission type, it is desirable, from the viewpoint of transmittance, for the material of the dielectric layer 47 and wiring to be transparent. When the liquid-crystal display device is of the reflection type, the material is not necessarily transparent, and can also be opaque, such as a metal.

Referring to FIGS. 9A and 9B, it is desirable that the total width W1+W2 of the width W1 of the stronger electric field region in the liquid-crystal layer 26 and the width W2 of the weaker electric field region should be equal to or less than 20 μm. If the total width W1+W2 is equal to or less than 20 μm, the alignment of the liquid-crystal molecules 46 can be controlled and a sufficient transmittance can be obtained. Moreover, it is more favorable that the total width W1+W2 is equal to or more than 6 μm. If the total width W1+W2 is equal to or more than 6 μm, it is possible to form a structure for producing stronger electric field regions and weaker electric field regions in the liquid-crystal layer 26 with a sufficiently high accuracy, which enables the liquid-crystal alignment to be produced more stably.

The total width W1+W2 is almost equal to the sum of the width of the part 17′ located between the slits 16 in the pixel electrode 17 and the width of the slit 16, the sum of the width of the part 17′ located between the electric layers 47 on the pixel electrode 17 and the width of the electric layer 47, or the sum of the width of the wire provided on the pixel electrode 17 and the width of the region located between the wires. Thus, it is more favorable that each of these widths is equal to or less than 20 μm and equal to or more than 6 μm.

As described above, a distribution of an electric field whose strength changes in a plane wave manner is produced in the pixel to control the optical characteristic of the liquid-crystal layer 26 in a display operation. When the control is performed, a stronger electric field than that above the slits 16 is obtained above the electrode section 17′ of the pixel electrode 17 in the liquid-crystal layer 26. As a result, the liquid-crystal molecules 46 above the electrode section 17′ of the pixel electrode 17 are inclined more than those above the slits 16. That is, in the liquid-crystal layer 26, the average tilt angle of the liquid-crystal molecules 46 above the electrode section 17′ of the pixel electrode 17 differs from that of the liquid-crystal molecules 46 above the slits 16. The difference in tilt angle can be observed as an optical difference.

Such a color liquid-crystal display device was configured as described below and its effect was checked.

Film formation and patterning were repeated in the same manner as the process of forming TFTs 12, thereby forming wiring, including scanning lines 41 and signal lines 40, and TFTs 12 on the substrate 11. A color filter layer 13 was formed so as to cover the TFTs 12. With a specific pattern mask, ITO was formed on the color filter layer 13 by sputtering techniques. After a resist pattern was formed on the ITO film, the exposed part of the ITO film was etched using the resist pattern as a mask, thereby forming a pixel electrode 17 with a pattern having slits 16 in it as shown in FIG. 6A. The width of each slit made in each pixel electrode 17 was set to 5 μm, and the width of the electrode section 17′ located between the slits 16 was also set to 5 μm.

Thereafter, a thermoset resin was applied to the whole surface at which the pixel electrode 17 was formed. The thermoset resin film was calcined, thereby forming a vertically alignment film 19 of 70 nm in thickness, which completed an array substrate 20.

The counter substrate 21 was formed as follows. An ITO film was formed on the main surface of the substrate 22 by sputtering techniques. The ITO film constituted a counter electrode 23. Then, thermoset resin was applied to the whole surface of the counter electrode 23. The thermoset resin film was calcined, thereby forming a vertically alignment film 24 of 70 nm in thickness, which completed a counter substrate 21.

Then, the array substrate 20 and the counter substrate 21 were aligned with each other by adjusting the ends of both the substrates 20, 23 without making high-accuracy positional adjustment using an alignment mark or the like in such a manner that the pixel electrode 17 and the counter electrode 23 faced each other. The peripheral sections of the facing surfaces were bonded with a seal material 25 except for the inlet for injecting liquid-crystal material, thereby forming a liquid-crystal panel 27. The cell gap of the liquid-crystal panel 27 was kept constant by causing 4-μm-high spacers 15 to intervene between both the substrates 20, 23.

Liquid-crystal material with negative dielectric anisotropy was injected into the liquid-crystal panel 27, thereby forming a liquid-crystal layer 26. After the liquid-crystal material was injected, the inlet was sealed with ultraviolet-curing resin, thereby completing the liquid-crystal panel 27.

The display characteristics, including transmittance and response time, of the liquid-crystal panel 27 were obtained as shown in test product 1 in Table 1.

Similarly, a pixel electrode 17 with a pattern having slits 16 as shown in FIG. 6B was formed. The width of each slit 16 made in each pixel electrode 17 was set to 4 μm, and the width of the electrode section 17′ located between the slits 16 was also set to 4 μm, thereby completing the liquid-crystal panel 27. With this configuration, the results as shown in test product 2 in Table 1 were obtained.

Furthermore, transparent acrylic photosensitive resin material was used in forming a 1.4-μm-thick pattern as shown in FIG. 1B to produce stronger and weaker electric field regions on the pixel electrode 17 effectively, in the same manner as described above. In addition, to produce an effective alignment, a liquid-crystal panel 27 divided into three regions by cutout sections (not shown) is formed. With this configuration, the results as shown in test product 3 in Table 1 were obtained.

On the other hand, in the same manner as described above, a pixel electrode 17 with a pattern having slits 16 as shown in FIG. 8C was formed. The width of each slit 16 made in each pixel electrode 17 was set to 4 μm, and the width of the electrode section 17′ located between the slits 16 was also set to 4 μm, thereby completing the liquid-crystal panel 27. With this configuration, the results as shown in test product 4 in Table 1 were obtained.

TABLE 1

| | Transmit- | Alignment | | |
|---|---|---|---|---|
| | tance | division | Response | After |
| | (%) | uniformity | time(ms) | image |
| Product 1 | 17 | Good | 25 | Little |
| Product 2 | 18 | Good | 23 | Little |
| Product 3 | 19 | Good | 29 | No |
| Product 4 | 18 | Good | 23 | No |

As seen from Table 1, although a high-accuracy positional adjustment is not made in bonding the array substrate 20 and the counter substrate 21 together, the liquid-crystal display device of the present invention has produced the effect of achieving excellent transmittance, alignment division uniformity, and response time. In test products 1 and 2, a slight afterimage occurred. However, in test products 3 and 4 which presented rotational symmetry four times and had no axial symmetry, the occurrence of such a sense of afterimage was not verified, which was an improvement in display characteristics.

The present invention is not limited to the above embodiment and may be modified in various ways. For instance, while both of the stronger electric field regions and the weaker electric field regions in the liquid-crystal layer 26 are made asymmetric with respect to an up and down direction to form a favorable configuration in terms of response speed, they may be made asymmetric in an up and down direction.

While the VAN mode in which a nematic liquid crystal with negative dielectric anisotropy is vertically aligned is used, a nematic liquid crystal with positive dielectric anisotropy may be used. When a high contrast is needed, the VAN mode is used in a normally black state, which enables a bright screen design with, for example, a high contrast of 400:1 or more and a high transmittance.

Furthermore, to make the optical response of liquid crystal seemingly faster, the angle formed where the light transmission easy axis or light absorption axis of the polarizing film crosses the alignment direction of the stronger electric field region and weaker electric field region may be shifted from 45° by a specified angle of θ. Although the angle θ can be set according to the viewing angle, setting the angle θ to 22.5° is the most effective in shortening the response time.

There is no limit to the shape of the parts 17a to 17d constituting the pixel electrode 17. For instance, they may be shaped like a rectangle or a fan. In the above embodiment, the structure for producing the stronger electric field region and the weaker electric field region in the liquid-crystal layer 26 is provided only on the array substrate 20 side, which eliminates the need for a high-accuracy alignment using an alignment mark or the like in laminating the array substrate 20 and the counter substrate 21 to form the liquid-crystal panel 27. The structure for producing stronger and weaker electric field regions may be provided on both of the array substrate 20 and the counter substrate 21. The color filter layer 13 may be provided on the counter substrate 21 side.

Furthermore, the spacers 15 may be of a single-layer type. In this case, photosensitive acrylic transparent resin is applied to the pixel electrode 17 with a spinner. After the applied resin is dried at 90° C. for 10 minutes, ultraviolet rays with a wavelength of 365 nm and an intensity of 100 mJ/cm² are projected onto the dried resin for exposure. Thereafter, the exposed resin is developed in an alkaline solution with a pH of 11.5. The resulting resin is calcined at 200° C. for 60 minutes, thereby forming single-layer spacers 15. In addition, the single-layer spacers 15 are formed at the same time the frame section 18 is formed out of a frame material by photolithographic techniques, which decreases the number of manufacturing processes. Moreover, bead-like spacers 1 may be used. Furthermore, the configuration, shape, size, material, and the like of the TFTs 12, etc., are not limited to those explained above and may be designed suitably.

As described above, with the present invention, a stronger electric field region and a weaker electric field region are formed at the pixel electrode. The alignment of the liquid-crystal molecules is controlled by the stronger and weaker electric field regions. The formation of the regions is provided only on the array substrate side,

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A liquid-crystal display device comprising:
an array substrate having pixel electrodes disposed on a main surface thereof;
a counter substrate having a counter electrode disposed to face the pixel electrodes on the main surface of said array substrate; and
a liquid-crystal layer held between said counter substrate and said array substrate;
wherein a pixel between the pixel electrode and the counter electrode is composed of four domains located around a center point of the pixel and each including stronger electric field regions and weaker electric field regions arranged alternately such that liquid-crystal molecules in the domains present four anisotropic alignment patterns deviated from each other by about 90°.

2. The liquid-crystal display device according to claim 1, wherein said four domains present rotational symmetry in directions deviated from each other by about 90°.

3. The liquid-crystal display device according to claim 1, wherein said four domains are non-axial symmetric.

4. The liquid-crystal display device according to claim 1, wherein said four domains present rotational symmetry in directions deviated from each other by about 90° and are non-axial symmetric.

5. The liquid-crystal display device according to claim 1, wherein slits are provided in said pixel electrode to produce the stronger and weaker electric field regions.

6. The liquid-crystal display device according to claim 1, wherein dielectric layers are provided on said pixel electrode to produce the stronger and weaker electric field regions.

7. The liquid-crystal display device according to claim 1, wherein wiring structures are stacked on the pixel electrode to produce the stronger and weaker electric field regions.

8. The liquid-crystal display device according to claim 1, wherein the width W1 of the stronger electric field region and the width W2 of the weaker electric field region are determined to satisfy the expression 6 μm≦W1+W2≦20 μm.
